(19) United States
(12) Patent Application Publication
(10) Pub. No.: US 2021/0335519 A1
(43) Pub. Date: Oct. 28, 2021

(54) CONDUCTIVE FILMS

(71) Applicant: Beijing Zenithnano Technology Co., Ltd., Beijing (CN)

(72) Inventors: Yuchun Zhang, Jiangsu Province (CN); Shudong Zhong, Beijing (CN)

(21) Appl. No.: 17/230,686

(22) Filed: Apr. 14, 2021

(30) Foreign Application Priority Data
Apr. 28, 2020 (CN) CN202010348897.2
Apr. 28, 2020 (CN) CN202010349470.4

(51) Int. Cl. H01B 5/14; G06F 3/041; H01B 1/02

(52) U.S. Cl. CPC H01B 5/14; H01B 1/026; G06F 3/0412

(57) ABSTRACT

The present disclosure discloses a conductive film, including a flexible substrate, an optical adjustment layer, a weathering layer, and an electrical conduction layer sequentially from bottom to top. The electrical conduction layer includes metal and an oxide/nitride of the metal, and a thickness of the electrical conduction layer is less than or equal to 10 nm. The present disclosure solves the problem of a poor electrical conduction effect caused by an island structure of metal serving as an electrical conduction layer, and improves the light transmittance of the conductive film.

### CROSS-REFERENCES TO RELATED APPLICATIONS

This application claims priority to Chinese Patent Application No. CN202010348897.2, entitled “CONDUCTIVE FILMS”, filed on Apr. 28, 2020, and Chinese Patent Application No. CN202010349470.4, entitled “CONDUCTIVE FILMS”, filed on Apr. 28, 2020, the entireties of which are incorporated herein by reference in their entirety for all purposes.

### TECHNICAL FIELD

The present disclosure relates to conductive films.

### BACKGROUND

In recent years, low-resistance conductive films have been widely used in various fields due to their low resistance, including solar cells, image sensors, liquid crystal displays, organic electroluminescence (OLED), and touch screen panels. In the fields, the industry is pursuing greater optical transparency and appropriate electrical conductivity over a required wavelength range, and is constantly innovating. Unfortunately, existing innovations are inadequate, and therefore new and improved methods and systems are desired.

### SUMMARY

In order to solve the above problems, the present disclosure provides a conductive film, including a flexible substrate, an optical adjustment layer, a weathering layer, and an electrical conduction layer sequentially from bottom to top, the electrical conduction layer including metal and an oxide/nitride of the metal, and a thickness of the electrical conduction layer is less than or equal to 10 nm.

Preferably, an atomic percentage of oxygen or nitrogen in the oxide/nitride of the metal is 1.5%-5.5%.

Preferably, a weight ratio of the metal to the oxide/nitride of the metal is 80-95:20-5.

Preferably, the electrical conduction layer includes a highest point and a lowest point, and a distance between the highest point and the lowest point is less than or equal to 3 nm.

Preferably, the metal is silver or copper.

Preferably, the electrical conduction layer is formed by magnetron sputtering.

Preferably, the sputtering includes placing a metal target in a chamber filled with inert gas and sputtering after oxygen or nitrogen is introduced; the inert gas is argon, and a filling volume of the argon is 280-320 sccm.

Preferably, an inlet volume of the oxygen or nitrogen is 2-10 sccm.

Preferably, the oxide of the metal or the nitride of the metal in the electrical conduction layer fills a depression of the metal.

Preferably, the oxide of the metal or the nitride of the metal in the electrical conduction layer is inter-doped with the metal. The present disclosure solves the problem of a poor electrical conduction effect caused by an island structure of metal serving as an electrical conduction layer in the prior art, and improves the light transmittance of the conductive film.

The present disclosure provides a conductive film, including a flexible substrate, an optical adjustment layer, a weathering layer, and an electrical conduction layer sequentially from bottom to top, the electrical conduction layer being made of metal, the electrical conduction layer including a highest point and a lowest point, a distance between the highest point and the lowest point being less than or equal to 3 nm, and the weathering layer being provided with a plurality of grooves.

Preferably, a thickness of the electrical conduction layer is less than or equal to 10 nm.

Preferably, the metal is silver, copper, or copper-silver alloy.

Preferably, the grooves are in a shape of strips or dots.

Preferably, a depth of the grooves is 2-3 nm.

Preferably, a width of the grooves is less than or equal to 4 nm.

Preferably, the grooves are formed on the weathering layer by laser.

Preferably, the electrical conduction layer is formed by magnetron sputtering, including placing a metal target in a chamber filled with inert gas and introducing oxygen or nitrogen during the sputtering.

Preferably, the inert gas is argon, and a filling volume of the argon is 280-320 sccm.

The present disclosure solves the problem of a poor electrical conduction effect caused by an island structure of metal serving as an electrical conduction layer in the prior art, and improves the light transmittance of the conductive film.

The present disclosure further provides a touch device including the above conductive film. The touch device has a good light transmission effect and sensitivity. There are other embodiments as well.

### BRIEF DESCRIPTION OF THE DRAWINGS

FIG. 1 is a view of SEM when a thickness of an Ag film is less than 10 nm.

FIG. 2 is a schematic cross-sectional view of an embodiment of a conductive film according to the present disclosure.

FIG. 3 is a schematic view of another embodiment of the conductive film according to the present disclosure.

FIG. 4 is a schematic view of another embodiment of the conductive film according to the present disclosure.

### DETAILED DESCRIPTION OF THE EMBODIMENTS

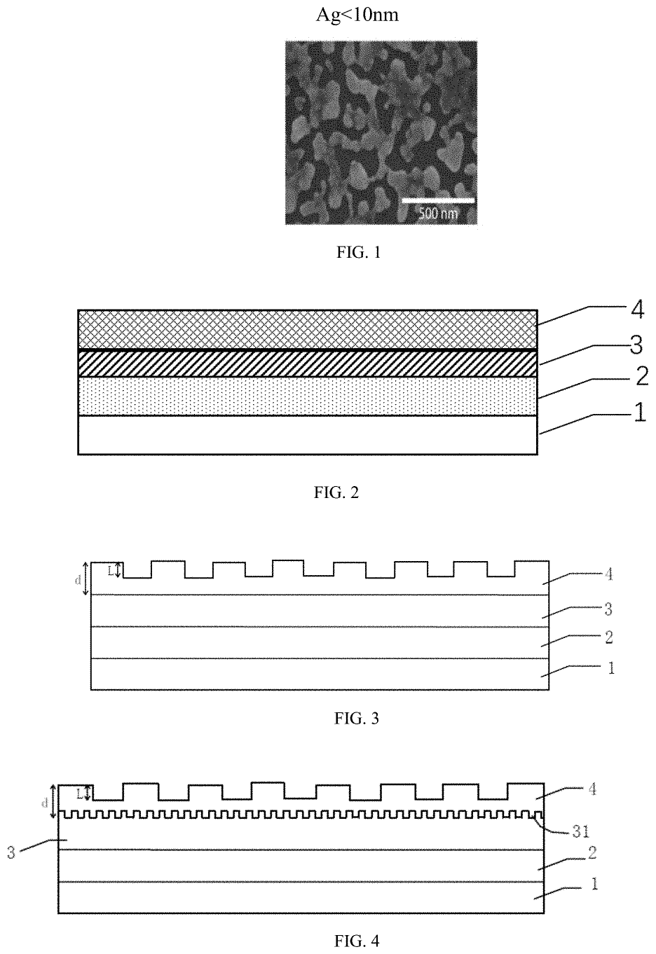

In a low-resistance conductive film structure, a composite laminated structure is usually adopted, among which a key electrical conduction layer is generally a metal layer. The electrical conduction layer has two important parameters affecting the low-resistance conductive film structure, of which one is the conductivity and the other is the light transmittance. That is, the electrical conduction layer should not be too thick; otherwise, the light transmittance may be affected. At the same time, the electrical conduction layer should not be too thin. If the electrical conduction layer is too thin, characteristics of metal may lead to an island structure in a sputtering process, that is, the whole metal film layer presents a discontinuous island shape, as shown in FIG. 1. The island structure affects the migration of metal particles, thus affecting the conductivity of the low-resistance conductive films.

By using words of orientation such as “atop”, “on”, “uppermost”, “below” and the like for positions of various elements in the laminated structure provided in the present disclosure, we refer to a relative position of an element with respect to horizontally-disposed, upwardly-facing support. It is not intended that the films or articles should have any particular orientation in space during or after their manufacture.

The term “island structure” in the present disclosure means that metal presents an island-like structure on a bearing layer on a micro level and the island is not connected to other islands.

The term “continuous structure” in the present disclosure means that the metal presents a shape like a continuous mountain on the bearing layer on a micro-level and has to be connected at the valley, or means that the metal presents a flat layered structure.

The term “optically transparent” when used with respect to a film or laminated glazing article means that there is no visibly noticeable distortion, haze, or flaws in the film or article as detected by the naked eye at a distance of about 1 meter.

The term “oxide/nitride of metal” means a binary compound composed of the metal and oxygen or a binary compound of the metal and nitrogen.

As shown in FIG. 2, the conductive film includes a flexible substrate 1, an optical adjustment layer 2, a weathering layer 3, and an electrical conduction layer 4 sequentially from bottom to top. The electrical conduction layer 4 includes metal and an oxide/nitride of the metal, and a thickness of the electrical conduction layer 4 is less than or equal to 10 nm. Properties of the electrical conduction layer 4 directly affect the conductivity and light transmittance of the conductive film structure. When the thickness of the electrical conduction layer 4 is less than or equal to 10 nm, the conductive film can maintain good light transmittance. However, when a pure metal layer serves as an electrical conduction layer, due to the high surface energy characteristics of the metal, an island structure may generally be formed with ordinary preparation methods. The island structure affects the migration of metal particles, thus affecting the conductivity of the conductive film structure. The electrical conduction layer 4 of the present disclosure solves this technical problem through a combination of metal and an oxide/nitride of the metal. Since surface energy of the oxide/nitride of the metal is less than that of the metal, after the metal and the oxide/nitride of the metal go through a particular sputtering method, the electrical conduction layer formed can maintain good light transmittance under the condition that the thickness is less than or equal to 10 nm and can also effectively alleviate the problem of forming an island structure. Preferably, as shown in FIG. 3, the thickness d of the electrical conduction layer 4 is 7 nm≤d≤10 nm. If the electrical conduction layer appears to have a highest point and a lowest point on a micro level, the thickness d herein refers to a vertical distance between the highest point and a surface of the weathering layer.

The flexible substrate 1 is preferably an optically transparent flexible substrate, and is made of one or more materials selected from a group consisting of polyethylene terephthalate (PET), polyimide (PI), polypropylene (PP), polystyrene (PS), cellulose triacetate (TAC), FMH acrylonitrile-butadiene-styrene (ABS), polyvinyl chloride (PVC), polycarbonate (PC), polyethylene (PE), polymethyl methacrylate (PMMA), polytetrafluoroethylene (PTFE), a cyclic olefin copolymer (COP, Arton), and polyethylene naphthalate (PEN).

The optical adjustment layer 2 removes chromatic aberration between the weathering layer, the electrical conduction layer, and other laminated structures after materials with different refractive indexes are selected for refractive index matching.

The weathering layer 3 means a layer structure to protect the electrical conduction layer from corrosion or oxidation through one or more layers.

In a specific implementation, a weight ratio of the metal to the oxide/nitride of the metal in the electrical conduction layer 4 is 80-95:20-5. Preferably, a weight ratio of the metal to the oxide/nitride of the metal is 85:15, 87:13, 90:10, or 92:8. An atomic percentage of oxygen or nitrogen in the oxide/nitride of the metal is 1.5 at. %-5.5 at. %.

The present disclosure hopes to pursue higher conductivity while maintaining the transmittance. In the present disclosure, the conductivity is affected by two factors: one is a ratio of the metal to the oxide/nitride of the metal, because the conductivity of the metal is generally higher than that of its oxide/nitride, and the other is the selection of the metal. Therefore, when the ratio of the metal to the oxide/nitride of the metal is 80-95:20-5, the conductive film can maintain low resistance and excellent conductivity. When the atomic percentage of oxygen or nitrogen in the oxide/nitride of the metal is 1.5 at. %-5.5 at. %, the electrical conduction effect is good.

In a specific implementation, a distance between the highest point and the lowest point of the electrical conduction layer 4 is less than or equal to 3 nm. The present disclosure pursues a continuous structural electrical conduction layer with high electron mobility, and a distance L between the highest point and the lowest point of the electrical conduction layer is less than or equal to 3 nm. L herein refers to a vertical distance between a horizontal line of the highest point and a horizontal line of the lowest point of the electrical conduction layer. Preferably, 0 nm≤L≤2 nm.

The electrical conduction layer 4 includes metal and an oxide/nitride of the metal. From the perspective of microscopic forms, there are several forms: firstly, a metal layer and a metal oxide/nitride layer are superimposed, and preferably, the metal oxide/nitride layer is superimposed on the metal layer; secondly, the metal layer presents a discontinuous structure, and the metal oxide/nitride layer fills a depression of the metal layer; thirdly, the metal and the metal oxide/nitride are doped together in disorder. The microscopic form of the electrical conduction layer of the present disclosure can be either one of the above or a combination of more than two thereof. A specific form may be adjusted by the time of oxygen/nitrogen injection and an inlet volume of oxygen/gas.

In a specific implementation, the electrical conduction layer is formed by sputtering. The sputtering may be magnetron sputtering, dipole sputtering, quadrupole sputtering, or plasma sputtering. In another embodiment, the electrical conduction layer is formed by magnetron sputtering. Preferably, drum magnetron sputtering may be used, that is, the flexible substrate is sputtered at a constant speed under a certain linear velocity. The sputtering speed is 2-10 nm-m/min. In another embodiment, the electrical conduction layer is formed by sheet magnetron sputtering.

In a specific implementation, the sputtering includes placing a metal target in a chamber filled with inert gas and introducing oxygen or nitrogen during the sputtering. The metal target can be made of a single metal or an alloy metal, for example, two or more of a silver target, a copper target, a gold target, an aluminum target, a tungsten target, and a nickel target. Preferably, the inert gas is argon, and a filling volume of the argon is 280-320 sccm.

In a specific implementation, an inlet volume of the oxygen or nitrogen is 2-10 sccm. After oxygen or nitrogen is introduced, the metal on the metal target is bombarded to form a gas phase which reacts with oxygen or nitrogen in the chamber to form a corresponding metal compound. An inlet volume of oxygen or nitrogen affects the amount of the metal compound. The inlet volume of oxygen or nitrogen is controlled to be 2-10 sccm, so as to control the ratio of metal to the metal oxide/nitride, and further make the thickness of the electrical conduction layer less than or equal to 10 nm without producing an island structure. The conductive film has both high light transmittance and a good electrical conduction effect. In another implementation, an inlet volume of the oxygen or nitrogen is 4-8 sccm.

In order to make the objectives, technical solutions, and advantages of the present disclosure clearer, the present disclosure is further described in detail below in combination with embodiments. It is understood that the specific embodiments described herein are intended only to explain the present disclosure and are not to define the present disclosure.

Unless otherwise stated, the solvents, reagents, technical parameters, and equipment used in the present disclosure are all conventional solvents, reagents, methods, parameters, and equipment in the art.

### EXAMPLE 1

A PET flexible substrate coated with an optical adjustment layer and a weathering layer is placed into a vacuum chamber. The flexible substrate moves forward at a sputtering speed of 6 nm·m/min, and reactive magnetron sputtering is carried out on a silver target under 280-sccm argon and 10-sccm oxygen provided at a back pressure of 2*10⁻⁶ mbar.

### EXAMPLE 2

A PET flexible substrate coated with an optical adjustment layer and a weathering layer is placed into a vacuum chamber. Through sheet magnetron sputtering, reactive magnetron sputtering is carried out on a copper target under 320-sccm argon at a pressure of 1*10⁻⁶ mbar. After sputtering for 1 min, 8-sccm oxygen is introduced for further sputtering for 1 min.

As can be observed from the conductive film obtained in this embodiment under a scanning electron microscope (SEM), a microscopic form of the electrical conduction layer is that the metal layer presents a discontinuous structure, and the metal oxide/nitride layer fills depressions of the metal layer and is superimposed on the top of the metal layer.

### EXAMPLE 3

A PMMA flexible substrate coated with an optical adjustment layer and a weathering layer is placed into a vacuum chamber. The flexible substrate moves forward at a sputtering speed of 3 nm·m/min, and reactive magnetron sputtering is carried out on a copper target under 300-sccm argon and 6-sccm oxygen provided at a back pressure of 1.5*10⁻⁶ mbar.

### EXAMPLE 4

A TAC flexible substrate coated with an optical adjustment layer and a weathering layer is placed into a vacuum chamber. The flexible substrate moves forward at a sputtering speed of 8 nm·m/min, and a copper target is sputtered by reactive magnetron sputtering with 290-sccm argon and 4-sccm nitrogen provided at a back pressure of 2.5*10⁻⁶ mbar.

### COMPARATIVE EXAMPLE 1

A PET flexible substrate coated with an optical adjustment layer and a weathering layer is placed into a vacuum chamber. The flexible substrate moves forward at a sputtering speed of 6 nm·m/min, and reactive magnetron sputtering is carried out on a silver target under 280-sccm argon provided at a back pressure of 2*10⁻⁶ mbar.

### COMPARATIVE EXAMPLE 2

The condition of the comparative example is similar to that in Example 1, except that the inlet volume of oxygen is 11 sccm.

### COMPARATIVE EXAMPLE 3

The condition of the comparative example is similar to that in Example 4, except that the inlet volume of nitrogen is 1 sccm.

The following tests are conducted on the above examples and comparative examples:

1. The light transmittance of the conductive film under visible light at a wavelength of 380-780 nm is measured by a spectrophotometer.

2. The thickness d of the electrical conduction layer in the conductive film is tested using an SEM.

3. A distance L between a highest point and a lowest point of the electrical conduction layer in the conductive film is tested using an SEM.

4. A resistance value of the conductive film is tested using a four-terminal square resistor (ASTM D991) instrument.

Test results are shown in Table 1:

TABLE 1

| | Transmittance | Thickness d | Distance L | Resistance |
|---|---|---|---|---|
| | (%) | (nm) | (nm) | (Ω/□) |
| Example 1 | 89.5 | 9 | 2 | 5.2 |
| Example 2 | 88.6 | 7 | 1.5 | 6.7 |
| Example 3 | 88 | 5 | 0.8 | 7.8 |
| Example 4 | 87.5 | 4 | 0.5 | 9.5 |
| Comparative | 86 | 9 | 7 | 9 |
| Example 1 | | | | |
| Comparative | 88 | 9 | 2 | 12 |
| Example 2 | | | | |
| Comparative | 85.5 | 9 | 6.5 | 9.2 |
| Example 3 | | | | |

It can be confirmed from Example 1 and Comparative Example 1 in Table 1 that when metal and its oxide/nitride form a layered structure, the formation of the island structure can be reduced when a layer thickness is less than 10 nm, thereby effectively reducing the resistance.

It can be confirmed from Example 1, Comparative Example 2, and Comparative Example 3 that an inlet volume of oxygen or nitrogen affects a ratio of the metal to its oxide/nitride, thus affecting the resistance.

This embodiment provides a touch device, including a conductive film. The conductive film includes a flexible substrate 1, an optical adjustment layer 2, a weathering layer 3, and an electrical conduction layer 4 sequentially from bottom to top. The electrical conduction layer 4 includes metal and an oxide/nitride of the metal, and a thickness d of the electrical conduction layer 4 is less than or equal to 10 nm. The touch device of the present disclosure has higher sensitivity.

As shown in FIG. 4, the conductive film includes a flexible substrate 1, an optical adjustment layer 2, a weathering layer 3, and an electrical conduction layer 4 sequentially from bottom to top. The electrical conduction layer is made of metal, the electrical conduction layer 4 includes a highest point and a lowest point, a distance between the highest point and the lowest point is less than or equal to 3 nm, and the weathering layer 3 is provided with a plurality of grooves 31. Properties of the electrical conduction layer 4 directly affect the conductivity and light transmittance of the conductive film structure. When the thickness d of the electrical conduction layer 4 is less than or equal to 10 nm, the conductive film can maintain good light transmittance. In general, the metal forms a metal layer by chemical vapor deposition (CVD). Its high surface energy is easy to form an island structure. The island structure affects the migration of metal particles, thus affecting the conductivity of the conductive film structure. In the present disclosure, the weathering layer 3 is provided with a plurality of grooves 31 to increase the surface roughness of the bearing layer. When the metal is deposited on the weathering layer 3, it prevents the metal with high surface energy from forming an island structure while forming a layered structure.

A distance between the highest point and the lowest point of the electrical conduction layer 4 is less than or equal to 3 nm. The present disclosure pursues a high-electron-mobility electrical conduction layer of a continuous structure, and the distance L between the highest point and the lowest point of the electrical conduction layer 4 is less than or equal to 3 nm. L herein refers to a vertical distance between a horizontal line of the highest point and a horizontal line of the lowest point of the electrical conduction layer.

The flexible substrate 1 is preferably an optically transparent flexible substrate, and is made of one or more materials selected from a group consisting of polyethylene terephthalate (PET), polyimide (PI), polypropylene (PP), polystyrene (PS), cellulose triacetate (TAC), FMH acrylonitrile-butadiene-styrene (ABS), polyvinyl chloride (PVC), polycarbonate (PC), polyethylene (PE), polymethyl methacrylate (PMMA), polytetrafluoroethylene (PTFE), a cyclic olefin copolymer (COP, Arton), and polyethylene naphthalate (PEN).

The optical adjustment layer 2 removes chromatic aberration between the weathering layer, the electrical conduction layer, and other laminated structures after materials with different refractive indexes are selected for refractive index matching.

The weathering layer 3 means a layer structure to protect the electrical conduction layer from corrosion or oxidation through one or more layers.

In other implementations, the thickness d of the electrical conduction layer 4 is less than or equal to 10 nm. When the thickness d of the electrical conduction layer 4 obtained by the present disclosure is less than or equal to 10 nm, there is no island structure and electron mobility is high. The thickness d of the electrical conduction layer 4 herein refers to a vertical distance between the highest point of the conductive layer and the surface of the weathering layer 3.

In a specific implementation, the surface roughness Ra of the weathering layer 3 is 3-8 nm.

In other implementations, the grooves 31 on the weathering layer 3 are of an unlimited shape, and are preferably in a shape of long strips or dots. The “long strips” herein refer to a shape extending linearly with a certain width in a microscopic form, and the width herein is less than or equal to 4 nm. The “dots” herein refers to a dot shape viewed by the naked eye macroscopically, and preferably a cambered depression, a cylindrical depression, or a conical depression in the microscopic form. An intersecting plane between the depression and the weathering layer is in a shape of a circle, and the diameter of the circle herein is less than or equal to 4 nm. The width of the long strips or the diameter of the circle is less than or equal to 4 nm because a maximum diameter of a bottom island circumference of the island structure is 4 nm under normal conditions. The metal does not form an island in a groove or depression during deposition, and the surface roughness of 3-8 nm can effectively resist the surface energy of the metal, thus eliminating the problem of the island structure. The grooves 31 on weathering layer 3 can be formed by laser etching or particle spraying.

In other implementations, the grooves are strip cross (X type, Z type) grooves, a diffusion effect is more obvious at the intersection during metal deposition, thereby effectively inhibiting an island effect.

Preferably, the electrical conduction layer 4 is formed by magnetron sputtering. In a specific implementation, the sputtering includes placing a metal target in a chamber filled with inert gas and introducing oxygen or nitrogen during the sputtering. The metal target can be made of a single metal or an alloy metal, for example, two or more of a silver target, a copper target, a gold target, an aluminum target, a tungsten target, and a nickel target. Preferably, the inert gas is argon, and a filling volume of the argon is 280-320 sccm.

This embodiment provides a touch device, including a conductive film. The conductive film includes a flexible substrate 1, an optical adjustment layer 2, a weathering layer 3, and an electrical conduction layer 4 sequentially from bottom to top, the electrical conduction layer 4 is made of metal, the electrical conduction layer 4 includes a highest point and a lowest point, a distance between the highest point and the lowest point is less than or equal to 3 nm, and the weathering layer 3 is provided with a plurality of grooves 31. The use of the above conductive film in the touch device can effectively improve the light transmittance of the touch device. Since the electrical conductivity is effectively improved, thus improving the sensitivity of the touch device.

### EXAMPLE 5

A PET flexible substrate is coated with an optical adjustment layer and a weathering layer. Parallel strip grooves are carved into the weathering layer by using a laser device. A width of the strip grooves is 4 nm. Then the PET flexible substrate is placed in a vacuum chamber. The flexible substrate moves forward at a sputtering speed of 8 nm·m/min, and reactive magnetron sputtering is carried out on a copper target under 300-sccm argon provided at a back pressure of 2.5*10⁻⁶ mbar.

### EXAMPLE 6

A PET flexible substrate is coated with an optical adjustment layer and a weathering layer. Dotted grooves are carved into the weathering layer by using a laser device. A width of the dotted grooves is 3 nm. Then the PET flexible substrate is placed in a vacuum chamber. The flexible substrate moves forward at a sputtering speed of 7 nm·m/min, and reactive magnetron sputtering is carried out on a silver target under 310-sccm argon provided at a back pressure of 2.5*10⁻⁶ mbar.

### EXAMPLE 7

A PET flexible substrate is coated with the same optical adjustment layer and weathering layer as in Example 1. Strip cross (X type) grooves are carved into the weathering layer by using a laser device. A width of the strip grooves is 4 nm. Then the PET flexible substrate is placed in a vacuum chamber. The flexible substrate moves forward at a sputtering speed of 8 nm·m/min, and reactive magnetron sputtering is carried out on a silver target under 300-sccm argon provided at a back pressure of 2.5*10⁻⁶ mbar.

### EXAMPLE 8

A TAC flexible substrate is coated with an optical adjustment layer and a weathering layer. Strip cross (Z type) grooves are carved into the weathering layer by using a laser device. A width of the strip grooves is 2.8 nm. Then the TAC flexible substrate is placed in a vacuum chamber. The flexible substrate moves forward at a sputtering speed of 5 nm·m/min, and reactive magnetron sputtering is carried out on a copper-silver alloy target under 320-sccm argon provided at a back pressure of 2.5*10⁻⁶ mbar.

### COMPARATIVE EXAMPLE 4

A TAC flexible substrate is coated with an optical adjustment layer and a weathering layer and then is placed into a vacuum chamber. The flexible substrate moves forward at a sputtering speed of 5 nm·m/min, and reactive magnetron sputtering is carried out on a copper-silver alloy target under 320-sccm argon provided at a back pressure of 2.5*10⁻⁶ mbar.

### COMPARATIVE EXAMPLE 5

The comparative example is basically similar to Example 1, except that the width of the grooves is 5.5 nm.

The following tests are conducted on the above examples and comparative examples:

1. The surface roughness Ra of the weathering layer is measured using an atomic force microscope (AFM).

2. The light transmittance of the conductive film under visible light at a wavelength of 380-780 nm is measured by a spectrophotometer.

3. The thickness d of the electrical conduction layer in the conductive film is tested using an SEM.

4. A distance L between a highest point and a lowest point of the electrical conduction layer in the conductive film is tested using an SEM.

A resistance value of the conductive film is tested using a four-terminal square resistor (ASTM D991) instrument.

Test results are shown in Table 2:

TABLE 2

| | Roughness | Transmittance | Thickness d | Distance L | Resistance |
|---|---|---|---|---|---|
| | (nm) | (%) | (nm) | (nm) | (Ω/□) |
| Example 5 | 6.6 | 88.3 | 9 | 2 | 8 |
| Example 6 | 6.2 | 88.6 | 9 | 1.2 | 7 |
| Example 7 | 7.5 | 89 | 9 | 0.8 | 6.5 |
| Example 8 | 5.5 | 88 | 9 | 2.2 | 8.4 |
| Comparative | 2.5 | 86 | 9 | 9.1 | 17 |
| example 4 | | | | | |
| Comparative | 3.2 | 87.2 | 9 | 5.1 | 11 |
| example 5 | | | | | |

As shown in Table 2, it can be confirmed from Example 8 and Comparative Example 4 that the weathering layer is provided with a plurality of grooves, which can improve the surface roughness of the weathering layer, and effectively prevent the formation of an island structure when the metal forms a layered structure, thus reducing the resistance of the electrical conduction layer.

It can be confirmed from Example 5 and Comparative Example 5 that when the weathering layer is provided with the grooves, the width of the grooves is less than or equal to 4 nm, which can effectively improve the continuity of the electrical conduction layer and reduce the probability of the formation of the island structure.

Although the present disclosure is described in detail above, the foregoing description is in all respects only an illustration of the present disclosure and is not intended to limit its scope. Therefore, various improvements or transformations may be made without departing from the scope of the present disclosure.

1. A conductive film, comprising a flexible substrate, an optical adjustment layer, a weathering layer, and an electrical conduction layer sequentially from bottom to top, the electrical conduction layer comprising metal and an oxide/nitride of the metal, and a thickness of the electrical conduction layer being less than or equal to 10 nm.

2. The conductive film according to claim 1, wherein an atomic percentage of oxygen or nitrogen in the oxide/nitride of the metal is 1.5%-5.5%.

3. The conductive film according to claim 1, wherein a weight ratio of the metal to the oxide/nitride of the metal is 80-95:20-5.

4. The conductive film according to claim 1, wherein the electrical conduction layer comprises a highest point and a lowest point, and a distance between the highest point and the lowest point is less than or equal to 3 nm.

5. The conductive film according to claim 1, wherein the metal is silver or copper.

6. The conductive film according to claim 1, wherein the electrical conduction layer is formed by magnetron sputtering.

7. The conductive film according to claim 6, wherein the sputtering comprises placing a metal target in a chamber filled with inert gas and sputtering after oxygen or nitrogen is introduced; and the inert gas is argon, and a filling volume of the argon is 280-320 sccm.

8. The conductive film according to claim 7, wherein an inlet volume of the oxygen or nitrogen is 2-10 sccm.

9. The conductive film according to claim 1, wherein the oxide/nitride of the metal in the electrical conduction layer fills a depression of the metal.

10. The conductive film according to claim 1, wherein the oxide/nitride of the metal in the electrical conduction layer is inter-doped with the metal.

11. A conductive film, comprising a flexible substrate, an optical adjustment layer, a weathering layer, and an electrical conduction layer sequentially from bottom to top, the electrical conduction layer being made of metal, the electrical conduction layer comprising a highest point and a lowest point, a distance between the highest point and the lowest point being less than or equal to 3 nm, and the weathering layer being provided with a plurality of grooves.

12. The conductive film according to claim 11, wherein a thickness of the electrical conduction layer is less than or equal to 10 nm.

13. The conductive film according to claim 11, wherein the metal is silver, copper, or copper-silver alloy.

14. The conductive film according to claim 11, wherein the grooves are in a shape of strips or dots.

15. The conductive film according to claim 11, wherein a depth of the grooves is 2-3 nm.

16. The conductive film according to claim 11, wherein a width of the grooves is less than or equal to 4 nm.

17. The conductive film according to claim 11, wherein the grooves are formed on the weathering layer by laser.

18. The conductive film according to claim 11, wherein the electrical conduction layer is formed by magnetron sputtering, comprising placing a metal target in a chamber filled with inert gas and introducing oxygen or nitrogen during the sputtering.

19. The conductive film according to claim 18, wherein the inert gas is argon, and a filling volume of the argon is 280-320 sccm.

20. A touch device, comprising a conductive film, the conductive film comprising a flexible substrate, an optical adjustment layer, a weathering layer, and an electrical conduction layer sequentially from bottom to top, the electrical conduction layer being made of metal, the electrical conduction layer comprising a highest point and a lowest point, a distance between the highest point and the lowest point being less than or equal to 3 nm, and the weathering layer being provided with a plurality of grooves.
